(19) United States
(12) Patent Application Publication
(10) Pub. No.: US 2007/0188546 A1
(43) Pub. Date: Aug. 16, 2007

(54) Ink mist control system for an edge-to-edge printer

(76) Inventors: Thomas Daniel Brown, Frankfort, KY (US); Stephen Andrew Budelsky, Lexington, KY (US); Mark Aaron Neal, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/351,752

(22) Filed: Feb. 10, 2006

(51) Int. Cl. B41J 2/165

(52) U.S. Cl. 347/34

(57) ABSTRACT

An ink-mist control system for an edge-to-edge printer having a scanning carriage and ink cartridge utilizing a printhead therein comprises a print zone disposed beneath the scanning carriage and ink cartridge utilizing a printhead, a T-shaped duct housing having a first housing portion and a second housing portion disposed beneath the print zone. The first housing portion has an inlet extending along the print zone, the second housing portion has an outlet. At least one basin waste collection is in fluid communication with the inlet to receive entrained ink particles, a first duct leg disposed in the first portion and a second duct leg offset from a lowermost position of the first duct leg, the first duct leg in fluid communication with the second duct leg. A fan is in fluid communication with said outlet for directing air and entrained ink mist particles from said inlet through said T-shaped duct and out said outlet. The air flow rate in the first duct leg is at a first velocity sufficient to entrain the ink mist while the air flow rate in the second duct leg is less than that of the first duct leg.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates generally to an ink mist control system, and more particularly to an ink mist control system which improves edge-to-edge printing.

2. Description of the Related Art

Digital photo printing has increased in popularity in recent years due to the increased popularity of digital cameras. Generally, digital cameras convert an optical image to a digital image through a charge-coupled device (CCD) image sensor or the like. The digital image may then be saved to an image memory for further data processing. In recent years digital camera features have improved significantly. For example, digital camera resolutions and memory storage capabilities have increased while prices for such features have steadily decreased, leading to increased digital camera sales. As a result of increased use of digital cameras, edge-to-edge photo printing has increased. Users desire developed pictures having the look, feel and size of photos developed by professional developers.

Manufacturers have developed various photo printers which render the digital images on media with results comparable to professionally developed photos. Current manufacturers have primarily utilized inkjet technology in order to create high quality photo prints. In conventional inkjet printers, there may be a carriage having containing one or more removable ink cartridges. Each cartridge may utilize a printhead for directing ink to a media sheet. The carriage unit is adapted to sweep the ink cartridge in a path of travel adjacent to the media, which is typically moved in a transverse or orthogonal direction to the carriage unit. As the printhead sweeps adjacent to the media, ink droplets are ejected onto the medium sheet which is typically supported from below by a platen.

In conventional inkjet printing, manufacturers have strived to avoid ink smearing on the underside of a media sheet. Smearing may occur when ink is misdirected onto printer components adjacent the feedpath and the media touches such component. One way of avoiding ink on printer components is to retain margins, which are unprinted areas around the outside edges of the media. Accordingly, conventional printers inhibit ejection of ink onto the leading, trailing, and side edges of the medium sheet. This creates sheet margins, and in turn, protects components on the media feedpath from receiving ink droplets being ejected by the printhead. However, the advent of photo printing has led to a desire to print edge-to-edge images, having the detailed photo image up to the media edge, which appear similar to professionally developed photographs.

To ensure that there are no blank areas along the media edges and to compensate for media positional errors in the media feedpath, the printhead must also eject ink from nozzles which are slightly beyond the edge of the media. This ensures that the printed area will include the edges of the media and eliminate blanks therealong. However, since the perimeter of the media must be oversprayed to ensure printed ink along the edges, ink ejected from the nozzles contaminates areas where media is not present and may adhere to the printer components generally adjacent the print zone, such as the platen or ribs. When subsequent media passes through this area, ink may be unavoidably transferred onto the surface of the media facing the platen or ribs.

Given the foregoing, it will be appreciated that an apparatus is needed which supports media moving through a print zone at a substantially constant distance from the printhead and also inhibits ink smearing on subsequent media.

### SUMMARY OF THE INVENTION

The present invention controls ink mist which is created during edge-to-edge printing processes.

According to a first exemplary embodiment, an ink-mist control system for edge-to-edge printer having a scanning carriage and ink cartridge utilizing a printhead therein comprises a print zone disposed beneath the scanning carriage and ink cartridge utilizing a printhead, a T-shaped duct housing having a first housing portion and a second housing portion disposed beneath the print zone. The first housing portion has an inlet extending along the print zone, the second housing portion has an outlet. At least one basin waste collection is in fluid communication with the inlet to receive entrained ink particles, a first duct leg disposed in the first portion and a second duct leg offset from a lowermost position of the first duct leg, the first duct leg in fluid communication with the second duct leg. The ink-mist control system further comprises an inlet lip extending upwardly from the duct body wherein the inlet is positioned. The ink-mist control system further comprises a primary waste collection basin disposed in the first housing portion opposite the inlet. The ink-mist control system further comprises a secondary waste collection basin disposed beneath the T-shaped duct housing. The printer further comprises a base portion. A secondary waste collection basin is disposed in the base. The inlet is in fluid communication with the first duct leg. The second duct leg is in fluid communication with the first duct leg and the fan. The primary waste collection basin is disposed in a lowermost position of the first duct leg and beneath an inlet to the second duct leg. The second housing portion further comprises a fan. The fan exhausts toward a front surface of said printer. The fan defining a second housing portion. The second housing portion being formed integral with the first housing portion and the fan mounted integrally internal of the second housing portion. The first duct leg has a first air velocity sufficient to entrain the ink mist and the second duct leg has a second air velocity of less than that of the first duct leg. For example, the first duct leg may have a first air velocity of between about five and seven meters per second therein. The second duct leg has a second air velocity of less than about 5 meters per second therein.

According to a secondary exemplary embodiment, a mist control system for an inkjet printer having a media feedpath, comprises a printer midframe forming a media feedpath, a print zone disposed along the media feedpath in a direction perpendicular to the feedpath, a T-shaped duct housing having an inlet adjacent the print zone and an outlet spaced from said inlet, the inlet extending at least the width of the print zone, a first waste basin disposed at a lowermost position of the T-shaped duct housing, a second waste basin disposed beneath the duct housing. The T-shaped duct housing further comprises a first housing portion in fluid communication with a second housing portion. The first housing portion further comprises a first duct leg and a second duct leg in fluid communication with the inlet. The first duct leg is disposed substantially perpendicular to the second duct leg. The first duct leg has a first end defining the air inlet and a second end disposed below a first end of the second duct leg. The first duct leg has a flow rate of between about five and seven meters per second. The second duct leg has a flow rate of about less than 5 meters per second.

An ink-mist control device comprises a duct housing having an inlet disposed in one surface of the duct housing, a first duct leg disposed within the duct housing including a first end and a second end, the inlet disposed at the first end of the first duct leg, a second duct leg extending perpendicularly from the first duct leg and offset from the second end of the first duct leg, a primary waste ink basin disposed at the second end of the first duct. leg beneath the secondary ink basin, a secondary waste ink basin disposed in a base of the printer, a fan connected to the duct housing and in fluid communication with the second duct leg, the first duct leg and the inlet. The fan pulls air from the inlet through the duct housing and exhausting air toward an ink basin. The first duct leg has a rectangular cross-section. The second duct leg has a circular cross-section. A first duct portion and a second duct portion define a generally T-shaped duct housing. The inlet is disposed in a print zone of a media feedpath. The inlet forms a low pressure region in a print zone to entrain ink particles in an airflow. The first duct portion may have a flow rate of between about five and seven meters per second while the second duct portion has a flow rate of about five meters per second or less.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of the exemplary edge-to-edge printer;

FIG. 2 is a perspective view of the exemplary edge-to-edge printer of FIG. 1 with a cut-away section depicting the print zone and printing components;

FIG. 3 is a perspective view of a midframe of the edge-to-edge printer of FIG. 2;

FIG. 4 is a side-sectional view of the mid-frame depicting the position of the ink mist control system of the present invention;

FIG. 5 is a perspective view of the ink mist control system;

FIG. 6 is a side-sectional view of the ink-mist control system of FIG. 5; and,

FIG. 7 is a bottom perspective view of the midframe of FIG. 3 and base.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” “mounted,” and “communication” and variations thereof herein are used broadly and encompass direct and indirect connections, couplings, mountings and communications. In addition, the terms “connected” and “coupled” and variations thereof are not restricted to physical or mechanical connections or couplings.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

The term image as used herein encompasses any printed or digital form of text, graphic, or combination thereof. The term output as used herein encompasses output from any printing device such as color and black-and-white copiers, color and black-and-white printers, and all-in-one devices that incorporate multiple functions such as scanning, copying, and printing capabilities in one device. Such printing devices may utilize ink jet, dot matrix, dye sublimation, laser, and any other suitable print formats. The term button as used herein means any component, whether a physical component or graphic user interface icon, that is engaged to initiate output.

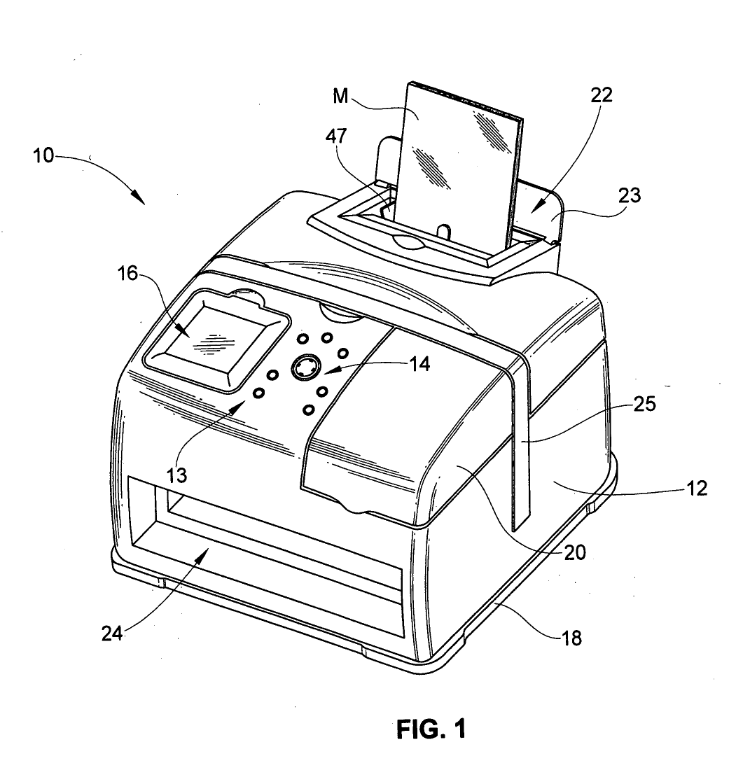

Referring now in detail to the drawings, wherein like numerals indicate like elements throughout the several views, there are shown in FIGS. 1-7 various aspects of an ink mist control system. The ink mist control system entrains and captures ink mist overspray in the print zone to decrease contamination of adjacent midframe components and direct the overspray mist into at least one waste ink containment area.

Referring initially to FIG. 1, an edge-to-edge printing device 10 is shown having a housing 12. The exemplary edged-to-edge printer 10 is shown and described herein is a photo printer, however one of ordinary skill in the art will understand upon reading of the instant specification that the present invention may be utilized with a stand alone printer, copier, or other printing device. Further, the present invention may be utilized with an inkjet peripheral device which performs edge-to-edge printing. The peripheral device 10 further comprises a control panel 13 on the housing 12 having a plurality of buttons 14 for making selections. The control panel 13 may include a graphics display 16 to provide a user with menus, choices or errors occurring with the system. The exemplary graphics display 16 may be a liquid crystal display (LCD) having an exemplary resolution of about 480×240 pixels but it is within the scope of the present invention that an alternative display type be utilized.

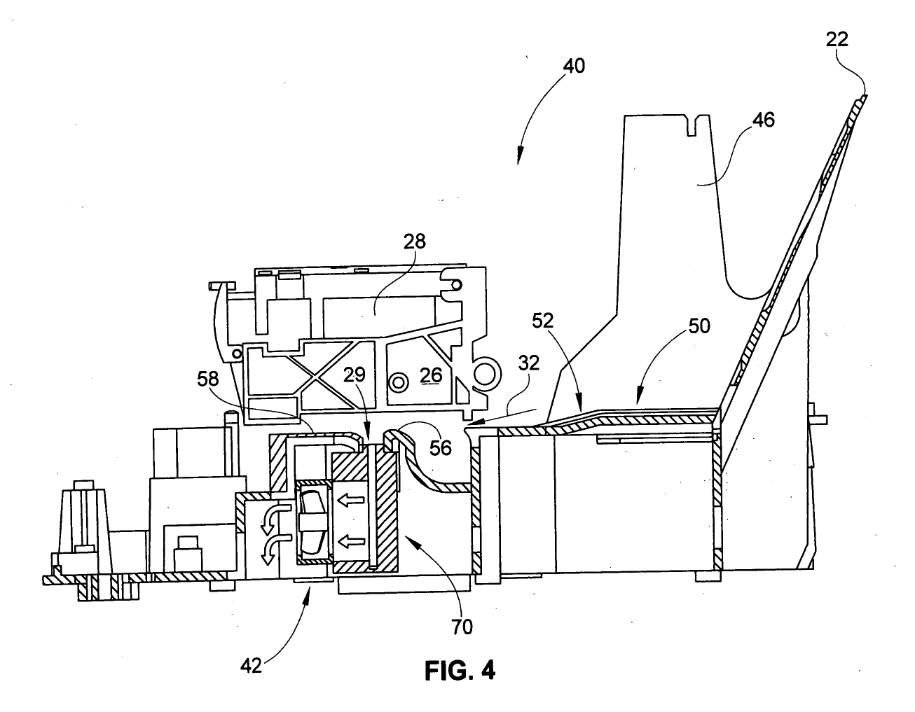

Still referring to FIG. 1, extending from the housing 12 is a media input 22 at the rear of the device 10 and a media output 24 at the front of the device 10 for retaining media M before and after a print process, respectively. The media input 22 includes a foldable media support 23 to support media M while such media M is located in a generally upright position. The media output 24 comprises an aperture in housing 12 along a front surface of the device 10. Adjacent the media input 22 is a door 20 providing access to the interior of the device 10 for changing ink cartridges (FIG. 4). Adjacent the access door 20 is a handle 25 to aid in carrying the device.

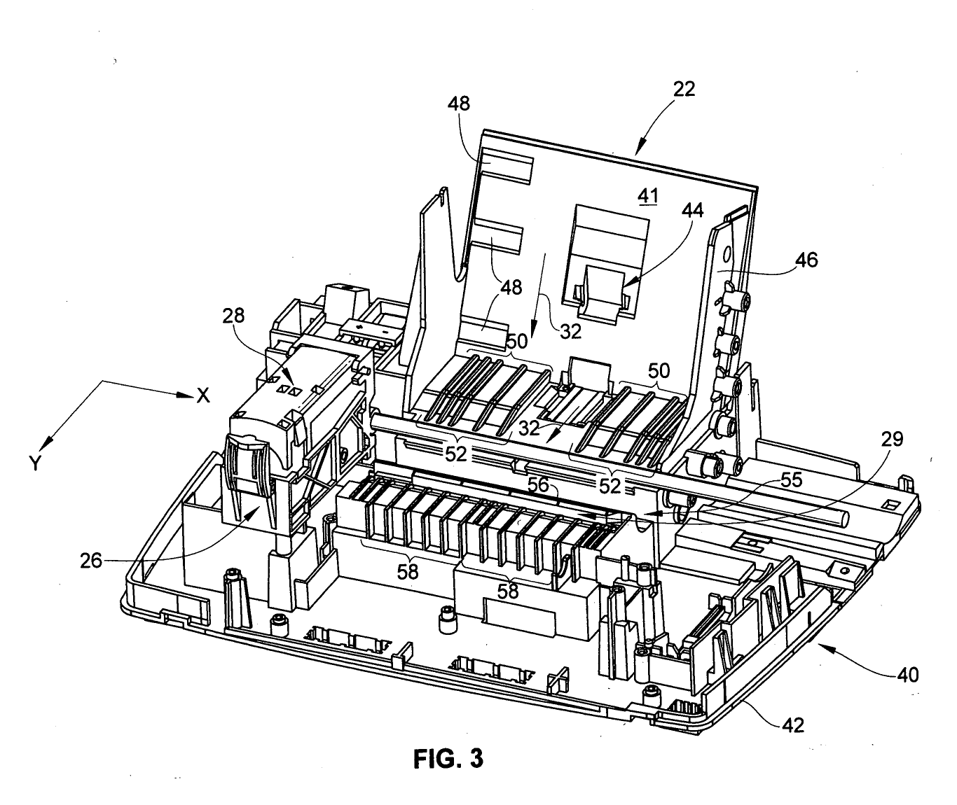

A media feedpath 32 (FIG. 3) extends between the input 22 and output 24. The media feedpath 32 is substantially L-shaped in the exemplary embodiment, but one skilled in the art will ascertain that the present invention may alternatively be used with a C-shaped or straight-through media feedpath.

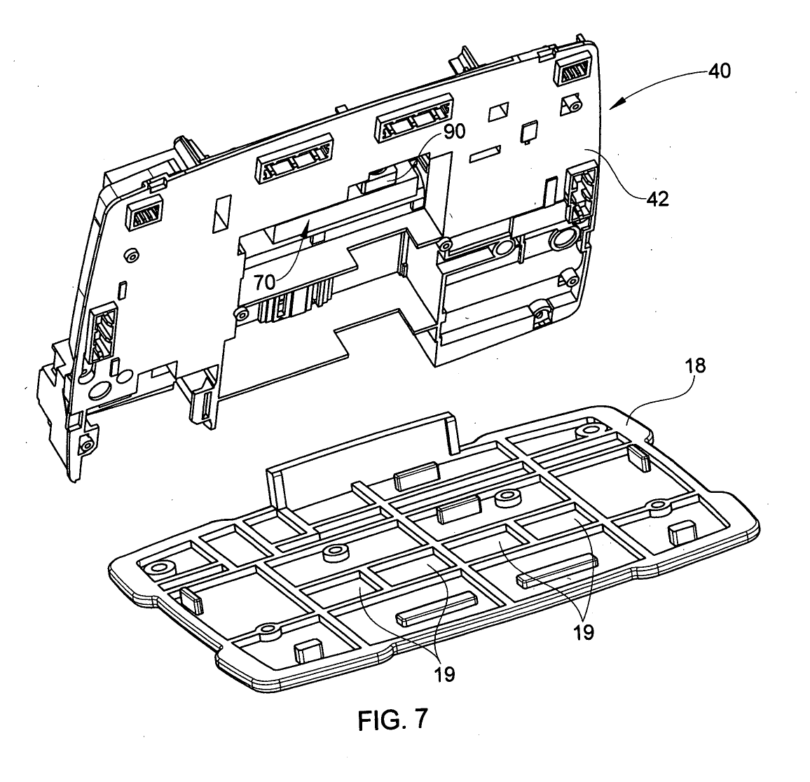

As shown in FIGS. 1 and 7, connected to the lower portion of printer 10 is a base 18 which may be connected in a plurality of ways to the housing 12. The base 18 may be formed of various materials which are impenetrable by ink, such as rubber or plastic. The base 18 may further comprise a basin 19 wherein particulate ink entrained by an ink control system 70 is directed. The basin 19 may define a volume wherein oversprayed ink is retained rather than contaminating internal components of the printer 10, which could deteriorate print quality. Since the basin 19 is located in the base 18, the base material should be impenetrable to inks to prevent them from leaking from the printer 10 and staining surrounding furniture or printer supporting surfaces.

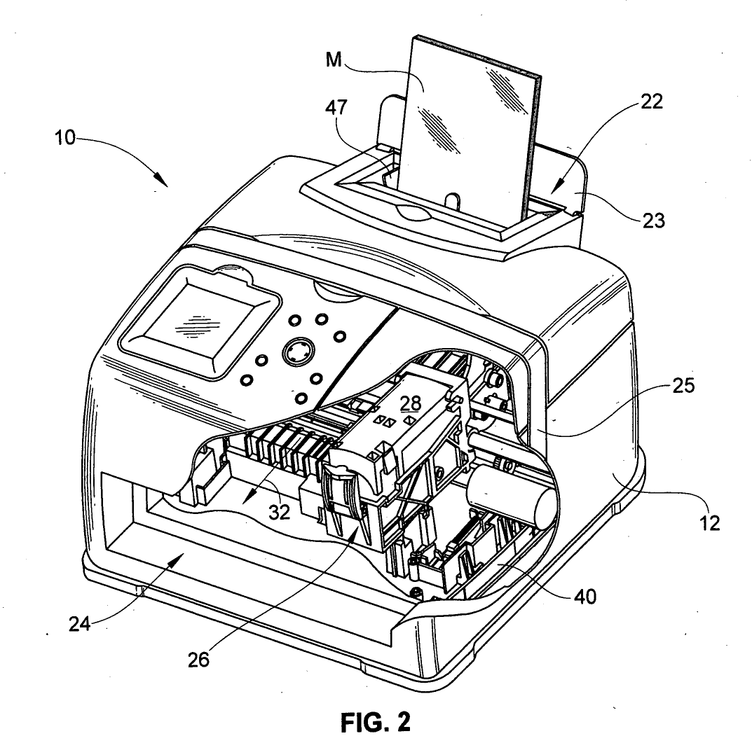

Referring now to FIG. 2, an interior cut-away perspective view of the printer device 10 is depicted. With the housing 12 cut-away, a carriage 26 having a position for placement of at least one print cartridge 28 is depicted. The one print cartridge 28 which may be, for instance, a color cartridge including three inks for photos i.e., cyan, magenta and yellow. Alternatively, multiple cartridges may be utilized including a color cartridge and a black ink cartridge for text printing or for photo printing or in another arrangement two color cartridges may be used where the second cartridge contains dilute cyan, magenta and yellow inks. During advancement media M moves from the media input 22 to the media output 24 along the substantially L-shaped media feedpath 32 (FIG. 3) beneath the carriage 26 and cartridge 28. As the media moves in a first Y-direction into a printing zone, the carriage 26 and the cartridges 28 move in a second, X-direction transverse to the movement of the media M. A driving signal from a print controller (not shown) causes reciprocating or scanning movement of carriage 26 based on received image data at the printer controller. The cartridge 28 is supplied with electric energy to generate a bubble ejecting ink to the adjacent media M. With housing 12 cut-away, the mid-frame 40 of the photo printer 10 is depicted beneath the carriage 26 and cartridge 28. The mid-frame 40 extends from the media input area 22 to the media output 24 thereby defining the media feedpath 32.

Referring now to FIG. 3, the mid-frame 40 is depicted in perspective view, removed from the housing 12 (FIG. 1). The mid-frame 40 comprises a lower surface 42 from which a plurality of molded parts extend. The media input 22 is depicted along a rear edge of the mid-frame base 42 extending upwardly at an angle therefrom. The media input 22 is generally defined by a planer structure or media input tray 41 having a substantially rectangular shape and an auto-compensating mechanism (ACM) pressure roller recess 44. The ACM is known to one of ordinary skill in the art and will not be discussed herein. The ACM pressure roller recess 44 allows positioning of a pressure roller (not shown) which, in combination with the ACM roller (not shown) forms a nip for indexing media M one sheet at a time from the input area 22 toward the print zone 29.

The media M is inserted at the media input 22 and against the planer surface defining the media input tray 41. Extending from the side edges of the tray 41 are media input sidewalls 46. The sidewalls 46 generally define the maximum media width that can be used in the edge-to-edge printing device 10. Adjacent one sidewall 46 is at least one channel or trough 48 wherein an automatic edge aligning device 47 (FIGS. 1 and 2) may be slidably positioned. The exemplary embodiment utilizes three channels 48. The troughs or channels 48 allow the edge aligning device 47 to move from an innermost position for narrow media to an outer position for receiving wider media within the input area 22. The edge aligning device 47 is biased, for instance spring biased, toward the opposite sidewall 46. This urges media M toward the opposite sidewall 46 so that the edges of the media M are aligned on one side by the sidewall 46 and the slidable edge aligning device 47 on the opposite side. Otherwise stated, the automatic edge aligning device 47 thus urges the media toward the right hand input sidewall 46 for automatically aligning the edges of the media M extending upright in the media input 22.

At a lower portion of the input tray 41 are a plurality of input ribs 50 extending in the Y-direction. The input ribs 50 are parallel in the direction of the feedpath 32. The input ribs 50 engage the lowermost edge of the media stack M inserted into the input area 22 and align the lower edge of the media stack M. Thus, the input ribs 50 align the lower edge of the media stack M and the automatic edge alignment guide 47 biases the media and aligns the perpendicular edges of the media stack M for consistent media feeding into the feedpath 32. In addition to aligning the lower media edge, the input ribs 50 extend in the Y-direction along the feedpath 32 and turn the media M from the upright position in the input area 22 to a substantially horizontal position for directing media through the print zone 29 and to the exit area 24. Extending from the downstream end of the input ribs 50 are transition ribs 52 which are tapered or angled from a first height at the input rib 50 to a second lower height adjacent a feed roller recess 55 to generally move the media to a lower elevation and toward the print zone 29. The roller recess 55 is generally disposed upstream of the print zone 29. When a feed roller (not shown) is placed in the roller recess 55, the feed roller indexes media into the print zone 29. The terms upstream and downstream are directional descriptors with respect to the Y-direction of the media feedpath 32, unless otherwise stated, wherein upstream refers to a direction toward the input area 22 and downstream refers to a direction toward output 24.

Downstream along the media feedpath 32 from the transition ribs 52 and adjacent the feed roller recess 55 is the cartridge path or print zone 29, which extends in a direction perpendicular to the media feedpath 32. The carriage 26 and cartridge 28 translate in: the X-direction along the cartridge path 29 and selectively eject ink onto an upper surface of a media sheet passing beneath the cartridge 28 to form an image thereon. If a duplexing media path is utilized, the cartridge 28 ejects ink onto both sides of the media in sequential fashion. Beneath the print zone 29 is the ink-mist control system 70 (FIG. 4).

Downstream of the print zone 29 are a plurality of exit ribs 58. The exit ribs 58 extend in the Y direction along the media feedpath 32 and support the leading edge of the media once the media passes the print zone 29. Similarly, the exit ribs 58 also support the media M when the trailing edge of the media is extended over the print zone 29. The media M is directed to the output area 24 by a driven exit roller (not shown).

Referring now to FIG. 4, a side-sectional view of the mid-frame 40 is depicted which further indicates the media feedpath 32 in relation to the ink control system 70 along the media feedpath 32. Downstream of the input area 22 and immediately adjacent the feed roller recess 55 is an entrance rib 56 on the upstream side of the ink mist control system 70. Opposite the entrance ribs 56 and downstream of the print zone 29 are the exit ribs 58. The entrance ribs 56 and exit ribs 58 are disposed at substantially the same elevation to support the media in a level orientation as it passes through the print zone 29. Also, entrance and exit ribs 56, 58 help maintain a constant distance from the cartridge 28 as the media moves through the print zone 29. The ink-mist control system 70 is located between the entrance ribs 56 and exit ribs 58 to collect ink mist from the print zone 29.

As media M moves downstream from the feed roller area 55 to the print zone 29, the leading edge of media M passes the entrance rib 56 and is indexed across the print zone 29. In order to ensure complete printing along the edges of the media M, the ink cartridge 28 oversprays along the media edges and into the print zone 29 in order to ensure an image is formed along the media edge. The ink-mist control system 70 collects excess ink mist in this region to limit contamination of adjacent components of the mid-frame 40 which would reduce print quality and/or printer life. The ink-mist control system 70 entrains ink mist into an airflow that is pulled from adjacent the print zone 29 into the control system 70 and subsequently through the ink-mist control system 70 to waste collection areas within the ink-mist control system 70 or to the secondary waste area or basin 19 within the base 18.

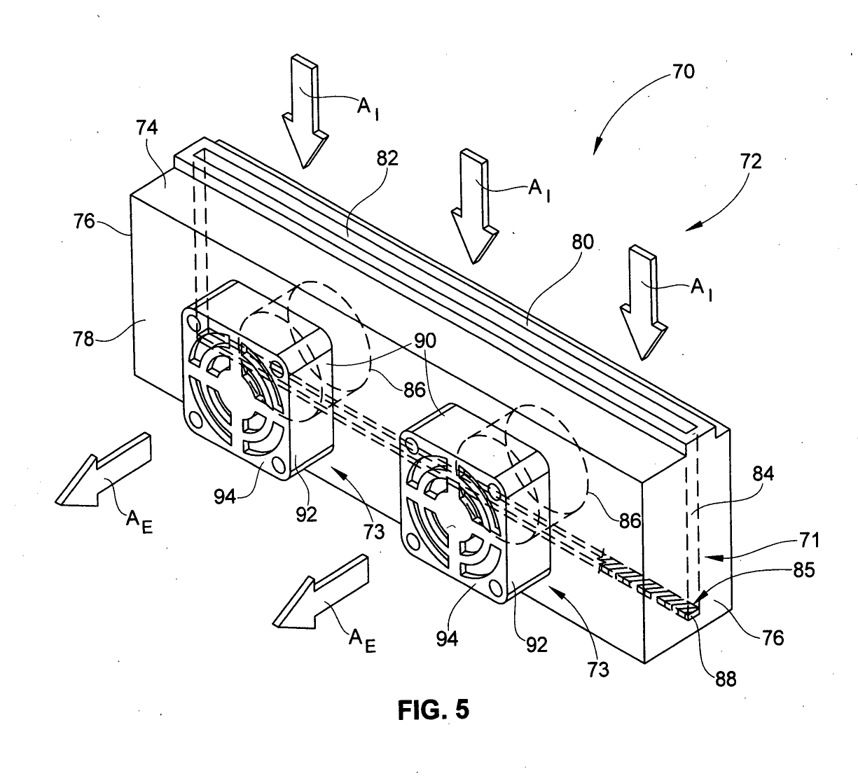

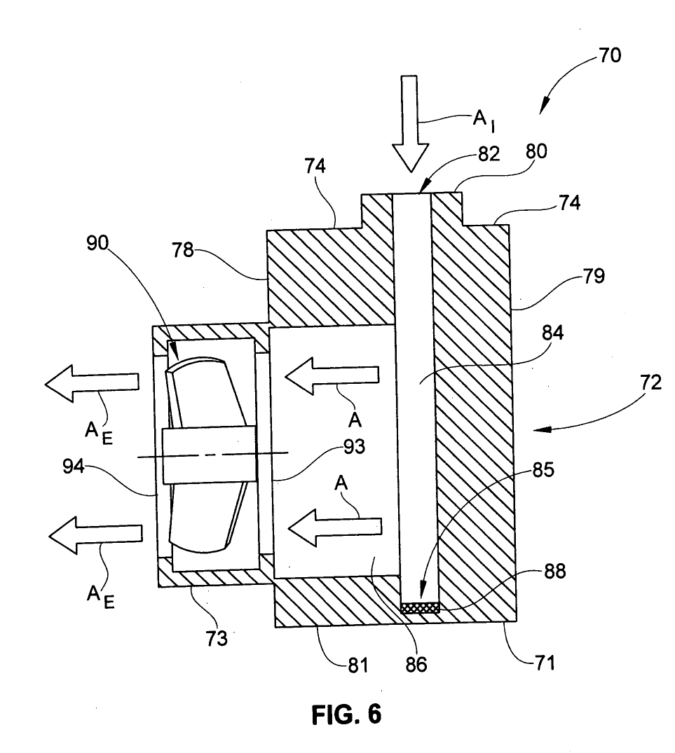

Referring now to FIGS. 5 and 6, the ink-mist control system 70 is shown in perspective view and in a side-sectional view, respectively. The ink-mist control system 70 comprises a generally T-shaped duct housing 72 formed of a first housing portion 71 and a second housing portion 73. The exemplary first housing portion 71 which is generally rectangular in cross-sectional shape, defining a volume. The first housing portion 71 is formed of an upper wall 74, opposed side walls 76 depending from the upper wall 74, air exhaust wall 78 depending from the upper wall 74 and extending between the side walls 76, a wall 79 opposite the exhaust wall 78 and a floor 81 which enclose the volume. Disposed along the upper wall 74 is an inlet lip 80 which extends upwardly from the upper wall 74 so that the inlet 82 is positioned in print zone 29 between entrance and exit ribs 56, 58. The inlet lip 80 comprises an air inlet 82 extending nearly the entire length of the inlet lip 80 in the longer dimension of the upper wall 74. The air inlet 82 is substantially rectangular in shape and, according to the exemplary embodiment, extends at least the width of the scanning path 29 in the X-direction. Further, the air inlet 82 may have a length in the X-direction, shown in FIGS. 2 and 3, which is equal to or longer than widest acceptable media dimension usable with the print device 10. Such media dimension in the X-direction may be less than the width of the scanning path in the X-direction.

Extending downwardly from the air inlet 82 is a first duct leg 84. The first duct leg 84 has a first air velocity sufficient to entrain the ink mist. The first duct leg 84 is substantially rectangular and extends vertically downward from a first end or the inlet 82. The first duct leg 84 also comprises a second end 85 opposite the inlet 82. The exemplary first duct leg 84 is rectangular in cross-sectional shape but other shapes may be utilized. The vertical length of the duct leg 84 is limited by the dimensions of the print device 10 and internal frame structure. The width of the duct leg 84 in the X-direction is equal to the width of the air inlet 82, as previously described. The first duct leg 84 is sized to form a pre-selected volume to control the flow rate of air and ink into the duct housing 72. The first duct leg 84 is sized for entraining the ink mist and accelerating the ink particles from the print zone 29 into the inlet 82. The entrained ink particles may be accelerated to a velocity of about 2-10 meters per second and more preferably about 5-7 meters per second. As the ink particles move through the first duct leg 84, the air flow rate and particles slow in velocity and may approach zero. As a result, the larger particles do not stay entrained at the slower flow rate and therefore cannot turn toward the second duct leg 86. Instead the larger particles fall out of the air stream and into a primary absorber at a second end of the first duct leg 82. One skilled in the art will recognize that varying the dimensions of the inlet 82 or first duct leg 84 will vary the flow rate therein as well as the varying the fan size.

At a second end 85 of the first duct leg 84 is a primary absorber 88. As the ink particles are directed from the inlet 82 to the second end 85 of the first duct leg 84, the air flow path makes a substantially perpendicular turn into the second housing portion 73. As previously indicated, the slower air flow near the second housing portion 73 causes the ink particles to fall out of the flow path entering the second housing portion 73 and into the primary absorber 88. The absorber 88 maybe formed of various materials having low weight and high absorbency characteristics. Such exemplary materials include foams, sponges or the like. One exemplary material that may be utilized as an absorber is hydrophilic felt. The absorber 88 is a primary absorbent which receives ink particles whose momentum carries the ink particles out of the air flow path moving into the second duct leg 86. The smaller and lighter particles remaining in the flow path are directed toward the second housing portion 73.

Extending substantially perpendicularly or orthogonally from the first duct leg 84 is at least one second duct leg 86 within the first housing portion 71. The first duct leg 84 and second duct leg 86 in combination define an exemplary T-shaped volume for fluid communication. The second duct leg 86 is offset from the lowermost position of the first duct leg 84 and has a larger volume which slows the flow rate of air and ink. It is believed that the slower flow rate at the second duct leg 86 aids in the depositing of ink particles at the primary absorber 88. This design provides for the position of the primary waste collection area and absorber 88 at the end 85 of the first duct leg 84. The amount of offset from the bottom end of first duct leg 84 should be sufficient is to contain the absorber 88 and need not be as long as illustrated in the figures. The amount of offset can be a minimal distance such that the T-shaped volume would appear more L-shaped. The exemplary second duct leg 86 has a cylindrical shape and extends from the downstream side of the first duct leg 84 toward the exhaust wall 78 of the duct housing 72. Although the second duct leg 86 has a circular cross-section and cylindrical shape, the geometry of the leg 86 may vary. The exemplary system 70 depicts two cylindrically shaped duct legs 86 extending between the first duct leg 84 and fans 90. The volumes of the cylindrical duct legs 86 are selected to provide a preselected flow rate slower than the first duct leg 84. The flow rate of the second duct leg 86 may be about 5 meters per second or less, for example. More preferably the flow rate in the second duct leg 86 is about 1.5 meters per second. As indicated by the arrows A_{E}, smaller ink particles which remain entrained in the air flow move through the second duct legs 86, through the fans 90 and into a secondary waste collection area 19, which may also utilize a hydrophilic felt as an absorber. Thus, the first duct leg 84 and the second duct leg 86 provide fluid communication between the air inlet 82 and the fans 90.

Extending perpendicular from the first housing portion 71 is a second housing portion 73. The second housing portion 73 may be defined by the fan 90 (FIG. 5) or may be an integral geometric structure with the first housing portion 71 and having the fans 90 located inside as shown in FIG. 6. The fans 90 each comprise a fan housing 92 including an intake side 93 and an exhaust side 94. The intake side 93 is in direct fluid communication with the duct leg 86. The exhaust side 94 comprises a plurality of apertures for exhausting air and remaining ink from the print zone 29. The exemplary fans 90 may be 5 volt DC, brushless motor and fan blades creating a flow rate of 0.4 to 1.8 cubic feet per minute (CFM) commercially available from Sunon, a Taiwanese Company. However, it should be understood that various fan and motor assemblies may be utilized and further that various geometries may be utilized in order to create the specific velocity flow necessary to maintain the ink mist entrained in the airflow and accelerate the ink particles into the first waste collection absorber 88. According to one exemplary embodiment, the fan 90 defines the second housing portion 73 and is connected to the first housing portion 71 as shown in FIG. 5. Alternatively, as shown in FIG. 6, the fan is formed within the second housing portion 73 which is integrally formed with the first housing portion 71.

The movement of air and ink is generally depicted with block arrows A, A_{I}, and A_{E}. Low pressure at the air inlet 82 pulls air and ink particles downwardly from the print zone labeled as A_{I}. The air and entrained ink mist A_{I} move through the air inlet 82 and the first duct leg 84. As the particles and air are accelerated to a desired velocity, the flow A_{I} makes a substantially perpendicular turn. The momentum of the larger particles carries those particles to the bottom 85 of first duct leg 84 into a primary absorber 88. The smaller and lighter particles which remain entrained in the flow are directed through the second duct leg 86 to the fan 90 to the exhaust side of the fan 94 where the air and ink move outward in the direction depicted as A_{E}. The remaining ink particles are directed into the base 18 and secondary waste collection area 19. As shown in FIG. 4, the direction A_{E} is generally oriented towards the front of the print device 10. Alternatively, the ink collection system 70 may be rotated to direct exhaust air and ink toward the rear of the device 10. Air A_{E} having any residual ink is directed to the basin 19 within base 18. The basin 19 may include an absorbent material 88 as well.

Referring now to FIG. 7, a perspective view of the base 18 and midframe 40 is shown, with the midframe 40 rotated about a horizontal axis from its normally operating position. In this view, the ink-mist control system 70 is shown extending through the midframe 40 as well as one fan 90. When the midframe 40 is positioned on the base 18, as shown in FIGS. 1 and 2, the fans 90 direct air and any remaining ink not collected in the primary waste collection area 85 into the base 18. Specifically, the base 18 comprises at least one secondary waste collection area or basin 19. The exemplary base 18 includes four basins extending the length of the print zone 29. Within the at least one basin 19 may be an absorbent material (not shown) such as foam or sponge material, as previously indicated.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. An ink-mist control system for an edge-to-edge printer utilizing a scanning carriage and printhead therein, comprising:
a print zone disposed beneath said scanning carriage and printhead;
a T-shaped duct housing having a first housing portion and a second housing portion disposed beneath said print zone;
said first housing portion having an inlet extending along said print zone;
said second housing portion having an outlet;
at least one basin waste collection in fluid communication with said inlet to receive entrained ink particles;
a first duct leg disposed in said first portion and a second duct leg offset from a lowermost position of said first duct leg, said first duct leg in fluid communication with said second duct leg; and
a fan in fluid communication with said outlet for directing air and entrained ink mist particles from said inlet through said T-shaped duct and out said outlet.

2. The ink-mist control system of claim 1 further comprising an inlet lip extending upwardly from said duct body wherein said inlet is positioned.

3. The ink-mist control system of claim 1 further comprising a primary waste collection basin disposed in said first housing portion opposite said inlet.

4. The ink-mist control system of claim 1 further comprising a secondary waste collection basin disposed adjacent said T-shaped duct housing.

5. The ink-mist control system of claim 4, said printer further comprising a base portion.

6. The ink-mist control system of claim 5 further comprising said secondary waste collection basin disposed in said base beneath said T-shaped duct housing.

7. The ink-mist control system of claim 1 wherein said inlet is in fluid communication with said first duct leg.

8. The ink-mist control system of claim 1 wherein said second duct leg is in fluid communication with said first duct leg and said fan.

9. The ink-mist control system of claim 1 wherein said primary waste collection basin is disposed in a lowermost position of said first duct leg and beneath an inlet to said second duct leg.

10. The ink-mist control system of claim 1, said second housing portion further comprising said fan.

11. The ink-mist control system of claim 10 wherein said fan defines a second housing portion.

12. The ink-mist control system of claim 10 said second housing portion being formed integral with said first housing portion and said fan being mounted internal of said second housing portion.

13. The ink-mist control system of claim 1 wherein said first duct leg has a first air velocity sufficient to entrain said ink mist and said second duct leg has a second air velocity of less than that of the first duct leg.

14. The ink-mist control system of claim 13 wherein said first duct leg has a first air velocity of between about five and seven meters per second therein and said second duct leg has a second air velocity of less than about 5 meters per second therein.

15. An ink-mist control system for an inkjet printer having a media feedpath, comprising:
a printer midframe forming a media feedpath;
a print zone disposed along said media feedpath in a direction perpendicular to said feedpath;
a T-shaped duct housing having an inlet adjacent said print zone and an outlet spaced from said inlet;
said inlet extending at least the width of said print zone;
a first waste basin disposed at a lowermost position of said T-shaped duct housing;
a second waste basin disposed beneath said duct housing; and
a fan in fluid communication with said outlet for directing air and entrained ink mist particles from said inlet through said T-shaped duct and out said outlet.

16. The ink-mist control system of claim 15, said T-shaped duct housing further comprising a first housing portion in fluid communication with a second housing portion.

17. The ink-mist control system of claim 15, said first housing portion further comprising a first duct leg and a second duct leg in fluid communication with said inlet.

18. The ink-mist control system of claim 17 wherein said first duct leg is disposed substantially perpendicular to said second duct leg.

19. The ink-mist control system of claim 18 wherein said first duct leg has a first end defining said air inlet and a second end disposed below a first end of said second duct leg.

20. The ink-mist control system of claim 17 wherein said first duct leg has a flow rate of between about five and seven meters per second.

21. The ink-mist control system of claim 20 wherein said second duct leg has a flow rate of about less than 5 meters per second.

22. An ink-mist control device, comprising:
a duct housing having an inlet disposed in one surface of said duct housing;
a first duct leg disposed within said duct housing including a first end and a second end;
said inlet disposed at said first end of said first duct leg;
a second duct leg extending perpendicularly from said first duct leg and offset from said second end of said first duct leg;
a primary waste ink basin disposed at said second end of said first duct leg beneath said secondary ink basin;
a secondary waste ink basin disposed in a base of said printer;
a fan connected to said duct housing and in fluid communication with said second duct leg, said first duct leg and said inlet; and,
said fan pulling air and entrained ink mist particles from said inlet through said duct housing and exhausting air toward an ink basin.

23. The ink-mist control device of claim 22 further comprising a first duct portion and a second duct portion, defining a generally T-shaped duct housing.

24. The ink-mist control device of claim 23 wherein said first duct portion has a flow rate of between about five and seven meters per second.

25. The ink mist control device of claim 24 wherein said second duct portion has a flow rate of about 5 meters per second or less.

26. The ink-mist control device of claim 22 wherein said inlet is disposed in a print zone of a media feedpath.

27. The ink-mist control device of claim 22, said inlet forming a low pressure region in a print zone to entrain ink particles in an airflow.
